(19) United States
(12) Patent Application Publication
(10) Pub. No.: US 2007/0064522 A1
(43) Pub. Date: Mar. 22, 2007

(54) Polish bottle spinner

(76) Inventor: Victor Etheridge, Suitland, MD (US)

Correspondence Address: LITMAN LAW OFFICES, LTD, PO BOX 15035, CRYSTAL CITY STATION, ARLINGTON, VA, 22215, US

(21) Appl. No.: 11/523,077

(22) Filed: Sep. 19, 2006

Related U.S. Application Data
(60) Provisional application No. 60/717,768, filed on Sep. 19, 2005.

(51) Int. Cl. B01F 11/00

(52) U.S. Cl. 366/214

(57) ABSTRACT

The polish bottle spinner is a spinning device to mix a liquid container of nail polish or other liquid. The polish bottle spinner has a base having a motor inside. The motor has a power connection that includes a user operable motor control. A drive shaft connected to the motor and vertically disposed axially engages a bottle-receiving platform for the transmission of torque to the receiving platform. The bottle-receiving platform is disposed above the base and has at least one generally cylindrical sidewall forming an aperture for lateral support of the bottle. A plurality of grippers with resilient bottle-engaging surfaces secures the bottle to the platform. A safety cap is provided that can be placed over the bottle while the platform is spinning. One of the sidewalls may be slidably attached to the bottle-receiving platform in order to directly engage the bottle to secure the bottle to the platform.

### CROSS-REFERENCE TO RELATED APPLICATION

This application claims the benefit of U.S. Provisional Patent Application Ser. No. 60/71 7,768, filed Sep. 19, 2005.

### BACKGROUND OF THE INVENTION

1. Field of the Invention

The present invention relates to mixing devices, and particularly to a polish bottle spinner for mixing a container of nail polish or other polishing liquid.

2. Description of the Related Art

Nail polish is a frequently used cosmetic that is applied to fingernails and toenails. Nail polish is sold in liquid form in small bottles with an applicator brush attached to the cap. The polish is a suspension that often settles to the bottom of the bottle before sale and between uses. In order to apply a coat of nail polish that is uniform in color, it is necessary to mix the contents of the bottle before each use. Most often the polish is mixed by shaking the bottle more or less vigorously by hand. While this may be adequate for the casual or occasional user, manually shaking the bottle becomes a wearisome chore for the more frequent user, such as a professional beautician or cosmetician in a salon or a retail establishment that specializes in polishing nails. There have been attempts to mechanize the bottle agitation process. For example, Japanese Patent No. 63-291,635 published Nov. 29, 1988, appears to disclose a device that permits a container to rotate while it is revolving, however does not appear to disclose the exact features of the present invention.

Thus, a polish bottle spinner solving the aforementioned problems is desired.

### SUMMARY OF THE INVENTION

The polish bottle spinner is a spinning device to mix a liquid container of nail polish or other liquid. The polish bottle spinner comprises a base having a motor inside. The motor has a power connection that includes a variable speed control for spin rate selection by a user. A drive shaft connected to the motor and disposed axially engages a bottle-receiving platform for the transmission of torque to the receiving platform. The bottle-receiving platform is disposed above the base and has at least one generally cylindrical sidewall forming an aperture for lateral support of the bottle. A plurality of grippers with a resilient bottle-engaging surface secure the bottle to the platform. A safety cap is provided that can be placed over the bottle while the platform is spinning.

These and other features of the present invention will become readily apparent upon further review of the following specification and drawings.

### BRIEF DESCRIPTION OF THE DRAWINGS

FIG. 1 is an environmental, perspective view of a polish bottle spinner according to the present invention.

FIG. 2 is a partially exploded side view of the polish bottle spinner according to the present invention.

FIG. 3 is a top plan view of the polish bottle spinner according to the present invention.

FIG. 4 is an exploded perspective view of the polish bottle spinner according to the present invention.

FIG. 5 is a top view of a polish bottle spinner according to the present invention having an alternative gripping mechanism.

FIG. 6 is a perspective view in section of the polish bottle spinner of FIG. 5.

FIG. 7 is a partially exploded side view of the polish bottle spinner of FIG. 5.

Similar reference characters denote corresponding features consistently throughout the attached drawings.

### DETAILED DESCRIPTION OF THE PREFERRED EMBODIMENTS

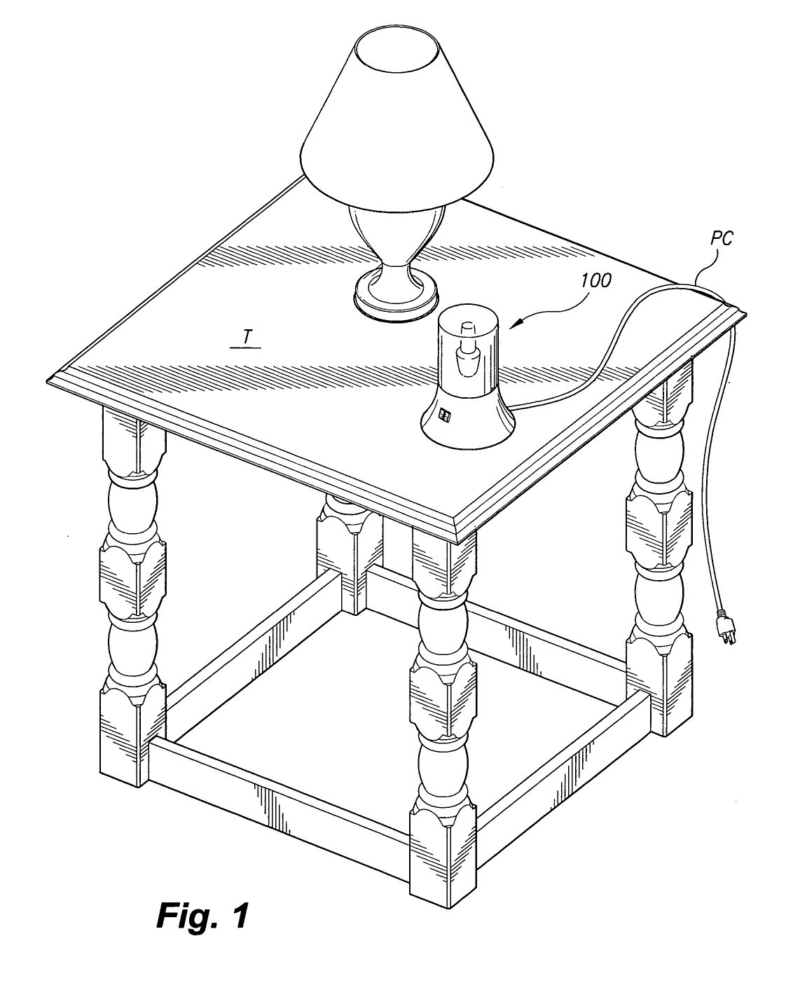

The present invention is a spinning device to mix a liquid container of nail polish or other liquid. FIG. 1 shows a polish bottle spinner 100 according to the present invention atop a lamp table. The spinner 100 is compact, self-supporting, and due to its small form, may be operated on virtually any flat surface, such as tabletop T.

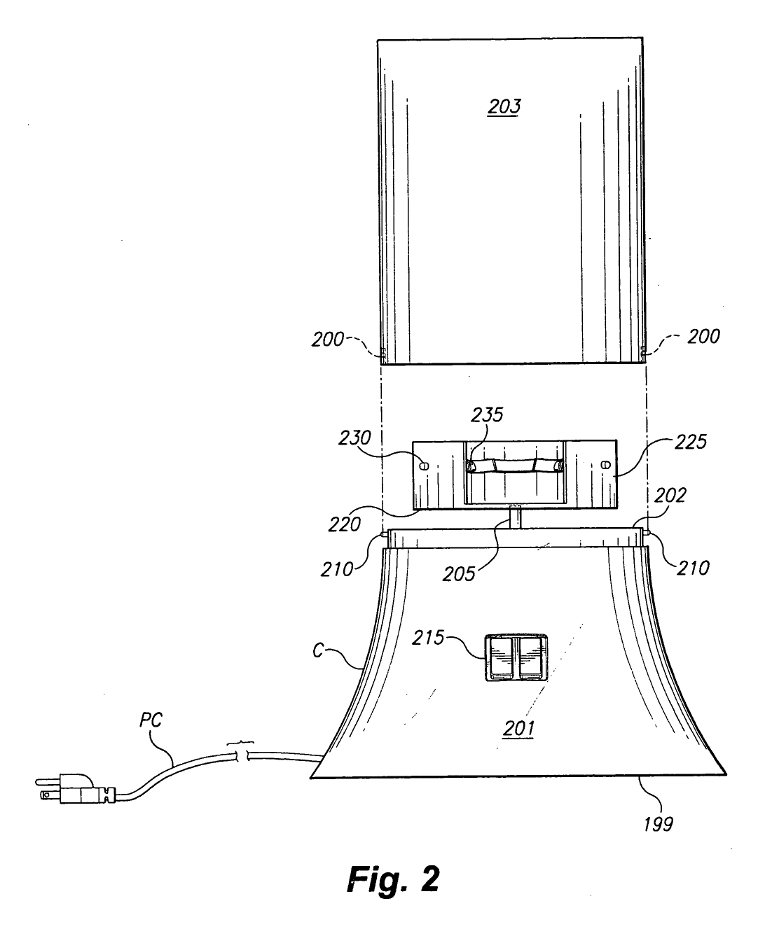

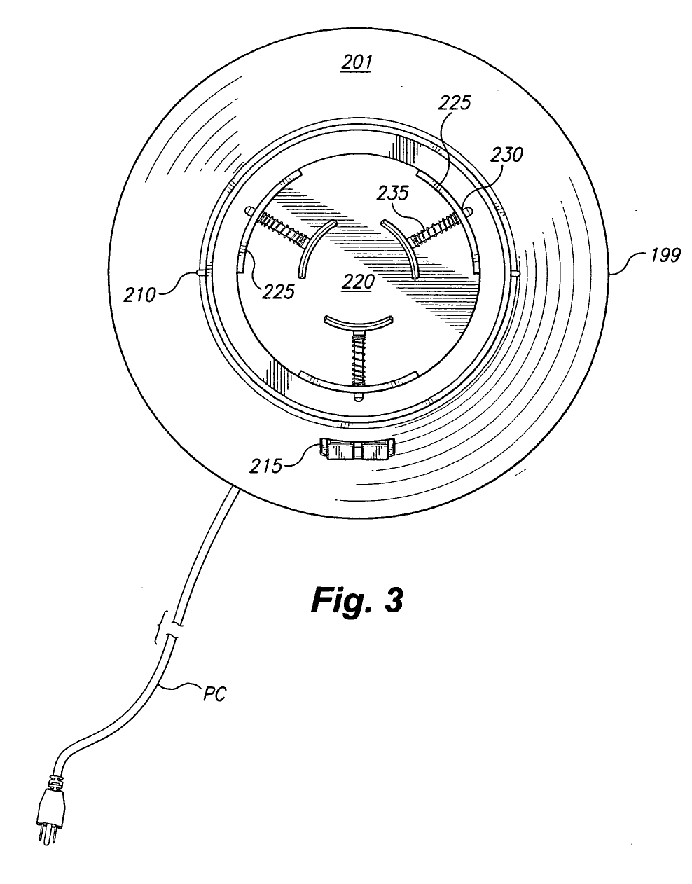

Referring to FIGS. 2-4, the polish bottle spinner 100 comprises a base 201 having a motor M inside. The motor M is connected to the power mains by a conventional power cord PC, and is controlled by at least one control switch 215 operable by a user. A drive shaft 205 is connected to the motor M and vertically disposed so that the drive shaft 205 axially engages a bottle-receiving platform 220 for transmission of torque to the receiving platform 220.

Base aperture 404, defined through a radial surface 402 of base 201, accommodates motor M and drive shaft 205 so that drive shaft 205 may engage the bottle-receiving platform 220 without interference from the base 201 or associated components. The bottle-receiving platform 220 is disposed above the base 201 and has at least one generally cylindrical or arcuate sidewall 225 forming an aperture for lateral support of a bottle PB.

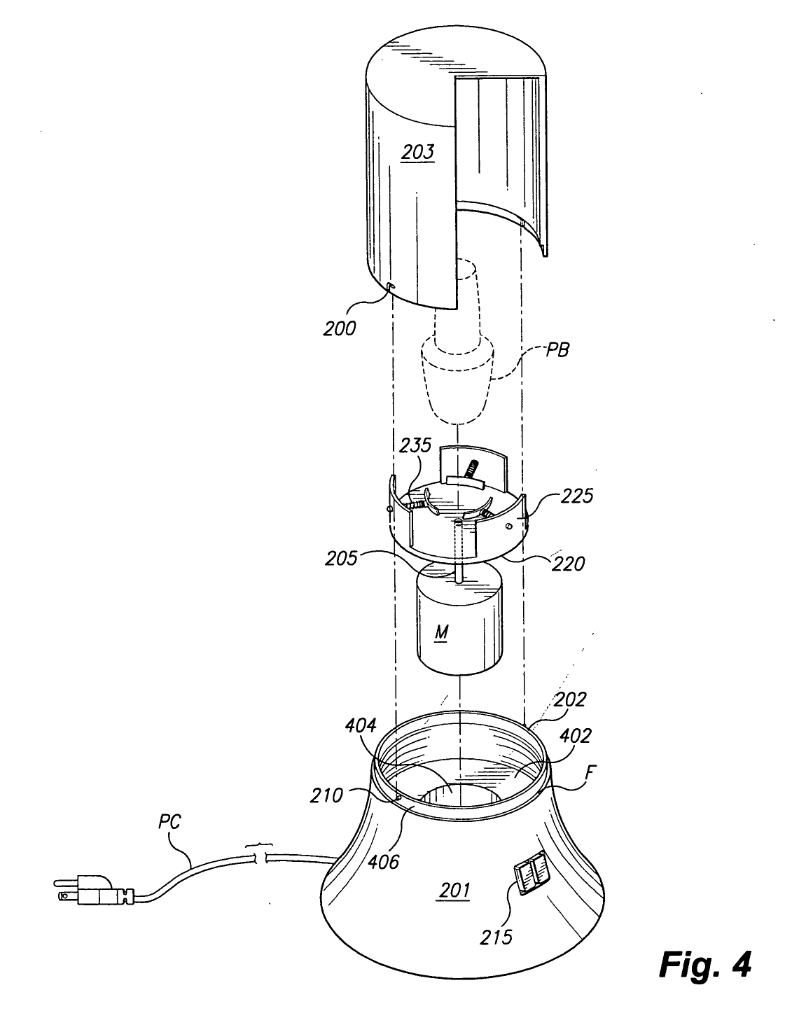

As shown in FIGS. 2 and 4, the base 201 has a shape defined by a circular lower edge 199, a circular upper edge 202 of smaller diameter and a concave surface C extending from the lower edge 199 to a predetermined distance below the upper edge 202 so that a flange F forms a vertical wall 406 extending to circular upper edge 202. The flange F provides a stable support for a protective cover 203.

The protective cover 203 provides additional safety to assure that, should a spinning bottle come loose while it is spinning, it will be stopped from impacting the surrounding environment by cover 203. Protective cover 203 has at least one L-shaped slot 200 provided for removable attachment to base 201 through engagement with a plurality of locking pins, such as locking pin 210.

As shown, motor M is mounted along an axial center of the base 201 to minimize vibration and to provide an esthetic, symmetrical appearance at an attachment of drive shaft 205 to platform 220. The attachment of drive shaft 205 to platform 220 may be a compression fit or any other coupling designed to provide an efficient transmission of torque from the motor M to the platform 220.

As shown in FIG. 4, power is supplied to the unit by power cord PC. Push buttons 215, which are user operable, may be provided for control of motor M, such as power control of motor M, speed control of motor M, or any combination thereof.

Referring to FIGS. 2, 3 and 4, a plurality of grippers, e.g., adjustable pins 235, extend inward from holes 230 in sidewall 225 to firmly secure the bottle to the platform 220. Grippers 235 may have a soft, resilient face for engaging the bottle. Although three grippers 235 spaced apart by 120° are shown in the drawings, the number of grippers 235 is not critical. The grippers 235 may be spring-loaded to provide a naturally compressive force on bottle PB when the bottle PB is placed on platform 220.

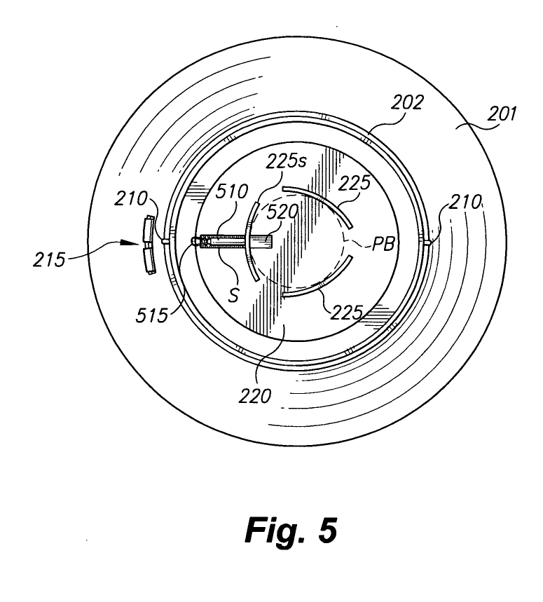

Alternatively, instead of grippers 235, sidewalls 225 can directly engage the bottle. As shown in FIGS. 5 through 7, sidewalls 225 are disposed radially inward from an outer edge of platform 220. At least one sidewall 225s is slidably attached to the platform 220 and is normally kept in a bottle-engaging position by means of a spring S that may be radially disposed within a channel 520 in platform 220.

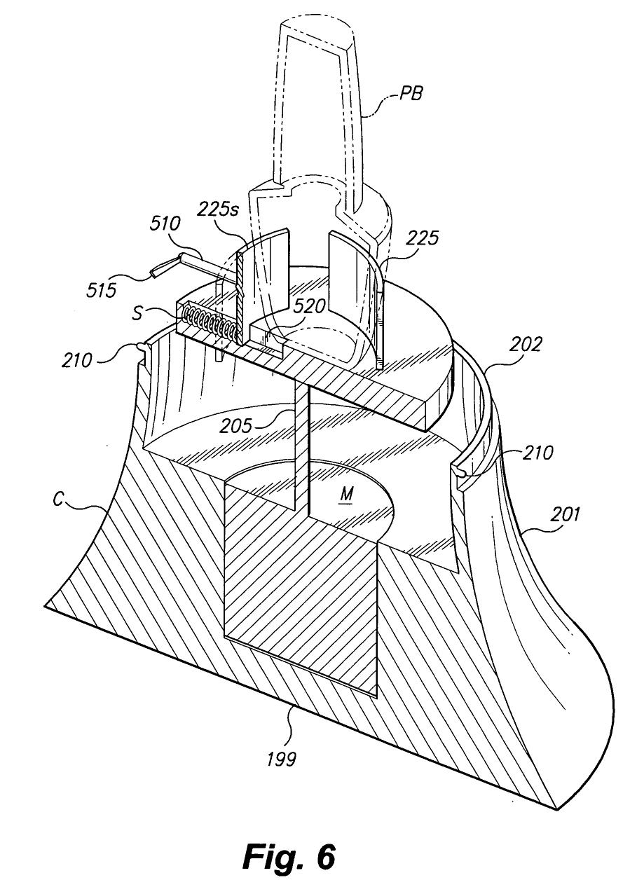

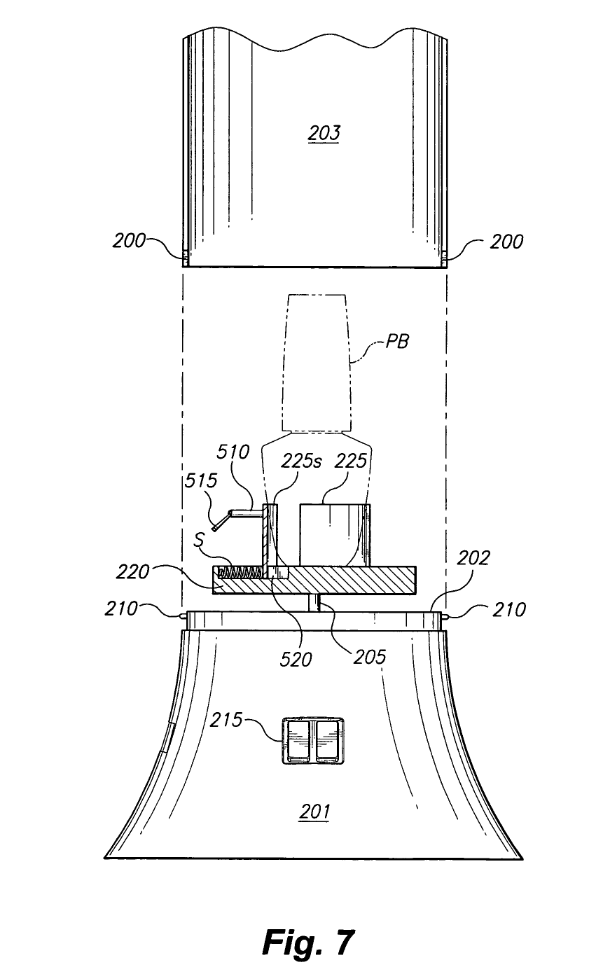

As most clearly shown in FIGS. 6 and 7, the spring S, being in contact with a lower portion of the slidable sidewall 225s, provides sufficient spring bias to keep sidewall 225s in the bottle-engaging position. A pull pin 510 is attached to and extends radially outward from an upper portion of sidewall 225s. Attached to a free end of pull pin 510 is a knob, or other device, such as handle 515 that can be grabbed by a user to pull the sidewall 225s outward for placement of the bottle PB onto the platform 220. To secure the bottle PB in place, the user lets go of the handle 515, thus allowing the spring force from spring S to return the sidewall 225s to the bottle engaging position so that the polish bottle PB is cradled by all of the sidewalls 225, 225s.

It is to be understood that the present invention is not limited to the embodiments described above, but encompasses any and all embodiments within the scope of the following claims.

I claim:

1. A polish bottle spinner, comprising:
a base;
a motor disposed within the base;
a user-operable motor control connected to the motor;
a drive shaft connected to the motor;
a bottle-receiving platform mounted over the base and attached to the drive shaft for rotation when the motor is activated;
at least one arcuate sidewall extending upward from the bottle-receiving platform, the arcuate sidewall forming an aperture for lateral support of a bottle placed on the bottle-receiving platform;
at least one adjustable pin adapted for gripping a polish bottle and securing the bottle to the platform for rotation therewith, the adjustable pin being disposed through an opening in the sidewall;
whereby polish in the bottle is mixed when the motor is activated to spin the platform.

2. The polish bottle spinner according to claim 1, wherein said user-operable motor control has push buttons operably connected to the motor for motor control, including power control and speed control.

3. The polish bottle spinner according to claim 1, wherein said base has a circular lower edge, a circular upper edge of smaller diameter than the lower edge, a concave surface extending from the lower edge, and an annular flange forming a vertical wall extending from the concave surface to the circular upper edge.

4. The polish bottle spinner according to claim 3, further comprising:
a protective cover supported by the flange.

5. The polish bottle spinner according to claim 4, wherein said protective cover has at least one slot defined therein, said base having locking pins releasably engaging the at least one slot of the protective cover for removably attaching said cover to said base.

6. The polish bottle spinner according to claim 1, wherein the at least one adjustable pin comprises three gripping pins spaced apart at approximately 120° intervals, each of the pins having a soft, resilient face for engaging the bottle.

7. The polish bottle spinner according to claim 1, wherein the at least one adjustable pin is spring-biased for resiliently engaging the bottle when the bottle is placed on the platform.

8. The polish bottle spinner according to claim 1, wherein said at least one arcuate sidewall comprises a pair of stationary sidewalls and a spring-biased sidewall slidably mounted on said platform, the sidewalls being radially spaced apart by about 120°.

9. A polish bottle spinner, comprising:
a base;
a motor disposed within the base;
a user-operable motor control connected to the motor;
a drive shaft connected to the motor;
a bottle-receiving platform mounted over the base and attached to the drive shaft for rotation when the motor is activated; and
a plurality of arcuate sidewalls extending upward from the bottle-receiving platform, the arcuate sidewalls being disposed radially inward from an outer edge of the receiving platform to form an aperture for lateral support of a bottle placed on the bottle-receiving platform, at least one of the plurality of arcuate sidewalls being slidable radially in order to cradle a polish bottle and secure the bottle to the platform for rotation therewith;
whereby polish in the bottle is mixed when the motor is activated to spin the platform.

10. The polish bottle spinner according to claim 9, wherein said platform has a radially extending channel defined therein, the spinner further comprising a spring disposed within the channel, the spring being in contact with a lower portion of the at least one slidable sidewall, the spring providing sufficient spring bias to keep the at least one slidable sidewall in a bottle- engaging position.

11. The polish bottle spinner according to claim 9, further comprising a pull pin attached to and extending radially outward from the at least one slidable sidewall, the pull pin being adapted for pulling the slidable sidewall outward for placement of a bottle onto the bottle-receiving platform.

12. The polish bottle spinner according to claim 11, further comprising a handle is attached to a free end of the pull pin.
